(19) United States
(12) Patent Application Publication
(10) Pub. No.: US 2026/0095863 A1
(43) Pub. Date: Apr. 2, 2026

(54) COMBINING LOW POWER WAKEUP SIGNAL AND EXTENDED DISCONTINUOUS RECEPTION CONFIGURATIONS

(71) Applicant: QUALCOMM Incorporated, San Diego, CA (US)

(72) Inventors: Chao WEI, Beijing (CN); Yuchul KIM, San Diego, CA (US); Wei YANG, San Diego, CA (US); Linhai HE, San Diego, CA (US); Ahmed ELSHAFIE, San Diego, CA (US)

(21) Appl. No.: 19/113,739

(22) PCT Filed: Nov. 14, 2022
(86) PCT No.: PCT/CN2022/131640

§ 371 Date: Mar. 20, 2025

(51) Int. Cl. H04W 52/02; H04W 76/28

(52) U.S. Cl. CPC H04W 52/0235; H04W 76/28

(57) ABSTRACT

Various aspects of the present disclosure generally relate to wireless communication. In some aspects, a user equipment (UE) may perform radio resource management (RRM) measurements according to a first periodicity associated with an extended discontinuous reception (eDRX) cycle. The UE may wake a main radio from a deep sleep state based at least in part on a low power wakeup receiver (LP-WUR) detecting a low-power wakeup signal (LP-WUS). The UE may monitor a paging occasion (PO) for a paging message using the main radio based at least in part on the LP-WUS, the PO having a time location associated with a second periodicity that differs from the first periodicity. Numerous other aspects are described.

### FIELD OF THE DISCLOSURE

Aspects of the present disclosure generally relate to wireless communication and to techniques and apparatuses associated with combining low power wakeup signal (LP-WUS) and extended discontinuous reception (eDRX) configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include performing radio resource management (RRM) measurements according to a first periodicity associated with an extended discontinuous reception (eDRX) cycle. The method may include waking a main radio from a deep sleep state based at least in part on a low power wakeup receiver (LP-WUR) detecting a low-power wakeup signal (LP-WUS). The method may include monitoring a paging occasion (PO) for a paging message using the main radio based at least in part on the LP-WUS, the PO having a time location associated with a second periodicity that differs from the first periodicity.

Some aspects described herein relate to a method of wireless communication performed by a UE. The method may include waking a main radio from a deep sleep state based at least in part on an LP-WUR detecting a UE-group LP-WUS associated with multiple UEs. The method may include transmitting, to a network node using the main radio, a preamble associated with a random access channel (RACH) procedure based at least in part on the UE-group LP-WUS. The method may include monitoring, using the main radio, a downlink channel for a random access response (RAR) message associated with the preamble.

Some aspects described herein relate to a UE for wireless communication. The UE may include memory, one or more processors coupled to the memory, and instructions stored in the memory and executable by the one or more processors. The instructions may be executable by the one or more processors to cause the user equipment to perform RRM measurements according to a first periodicity associated with an eDRX cycle. The instructions may be executable by the one or more processors to cause the user equipment to wake a main radio from a deep sleep state based at least in part on an LP-WUR detecting an LP-WUS. The instructions may be executable by the one or more processors to cause the user equipment to monitor a PO for a paging message using the main radio based at least in part on the LP-WUS, the PO having a time location associated with a second periodicity that differs from the first periodicity.

Some aspects described herein relate to a UE for wireless communication. The UE may include memory, one or more processors coupled to the memory, and instructions stored in the memory and executable by the one or more processors. The instructions may be executable by the one or more processors to cause the UE to wake a main radio from a deep sleep state based at least in part on an LP-WUR detecting a UE-group LP-WUS associated with multiple UEs. The instructions may be executable by the one or more processors to cause the UE to transmit, to a network node using the main radio, a preamble associated with a RACH procedure based at least in part on the UE-group LP-WUS. The instructions may be executable by the one or more processors to cause the UE to monitor, using the main radio, a downlink channel for a RAR message associated with the preamble.

Some aspects described herein relate to a non-transitory computer-readable medium that stores one or more instructions for wireless communication by a UE. The one or more instructions, when executed by one or more processors of the UE, may cause the UE to perform RRM measurements according to a first periodicity associated with an eDRX cycle. The one or more instructions, when executed by one or more processors of the UE, may cause the UE to wake a main radio from a deep sleep state based at least in part on an LP-WUR detecting an LP-WUS. The one or more instructions, when executed by one or more processors of the UE, may cause the UE to monitor a PO for a paging message using the main radio based at least in part on the LP-WUS, the PO having a time location associated with a second periodicity that differs from the first periodicity.

Some aspects described herein relate to a non-transitory computer-readable medium that stores one or more instructions for wireless communication by a UE. The one or more instructions, when executed by one or more processors of the UE, may cause the UE to wake a main radio from a deep sleep state based at least in part on an LP-WUR detecting a UE-group LP-WUS associated with multiple UEs. The one or more instructions, when executed by one or more processors of the UE, may cause the UE to transmit, to a network node using the main radio, a preamble associated with a RACH procedure based at least in part on the UE-group LP-WUS. The one or more instructions, when executed by one or more processors of the UE, may cause the UE to monitor, using the main radio, a downlink channel for a RAR message associated with the preamble.

Some aspects described herein relate to an apparatus for wireless communication. The apparatus may include means for performing RRM measurements according to a first periodicity associated with an eDRX cycle. The apparatus may include means for waking a main radio from a deep sleep state based at least in part on an LP-WUR detecting an LP-WUS. The apparatus may include means for monitoring a PO for a paging message using the main radio based at least in part on the LP-WUS, the PO having a time location associated with a second periodicity that differs from the first periodicity.

Some aspects described herein relate to an apparatus for wireless communication. The apparatus may include means for waking a main radio from a deep sleep state based at least in part on an LP-WUR detecting a UE-group LP-WUS associated with multiple UEs. The apparatus may include means for transmitting, to a network node using the main radio, a preamble associated with a RACH procedure based at least in part on the UE-group LP-WUS. The apparatus may include means for monitoring, using the main radio, a downlink channel for a RAR message associated with the preamble.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a discontinuous reception (DRX) configuration, in accordance with the present disclosure.

FIG. 4 is a diagram illustrating an example of a low power wakeup receiver (LP-WUR) and a low power wakeup signal (LP-WUS), in accordance with the present disclosure.

FIG. 5 is a diagram illustrating an example of an extended DRX (eDRX) configuration, in accordance with the present disclosure.

FIGS. 6A-6C illustrating examples associated with combining LP-WUS and eDRX configurations, in accordance with the present disclosure.

FIG. 7 is a diagram illustrating an example associated with UE behavior after detecting a UE-group LP-WUS, in accordance with the present disclosure.

FIG. 8 is a diagram illustrating an example process associated with combining LP-WUS and eDRX configurations, in accordance with the present disclosure.

FIG. 9 is a diagram illustrating an example process associated with UE behavior after detecting a UE-group LP-WUS, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

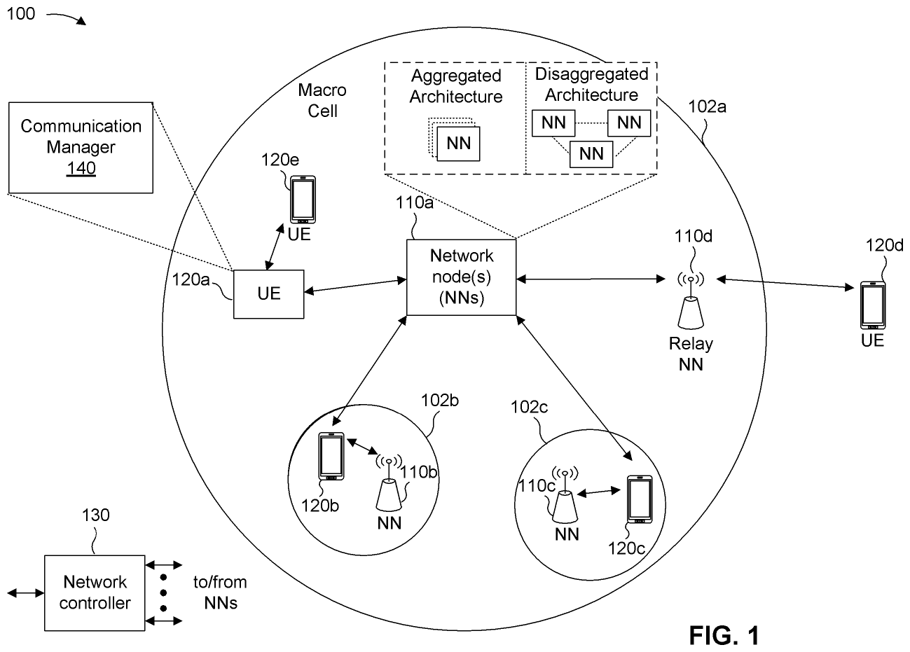

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform radio resource management (RRM) measurements according to a first periodicity associated with an extended discontinuous reception (eDRX) cycle; wake a main radio from a deep sleep state based at least in part on a low power wakeup receiver (LP-WUR) detecting a low-power wakeup signal (LP-WUS); and monitor a paging occasion (PO) for a paging message using the main radio based at least in part on the LP-WUS, the PO having a time location associated with a second periodicity that differs from the first periodicity. Additionally, or alternatively, the communication manager 140 may wake a main radio from a deep sleep state based at least in part on an LP-WUR detecting a UE-group LP-WUS associated with multiple UEs; transmit, to a network node using the main radio, a preamble associated with a random access channel (RACH) procedure based at least in part on the UE-group LP-WUS; and monitor, using the main radio, a downlink channel for a random access response (RAR) message associated with the preamble. Additionally, or alternatively, the communication manager 140 may perform one or more other operations described herein.

As indicated above, FIG. 1 is provided as an example. Other examples may differ from what is described with regard to FIG. 1.

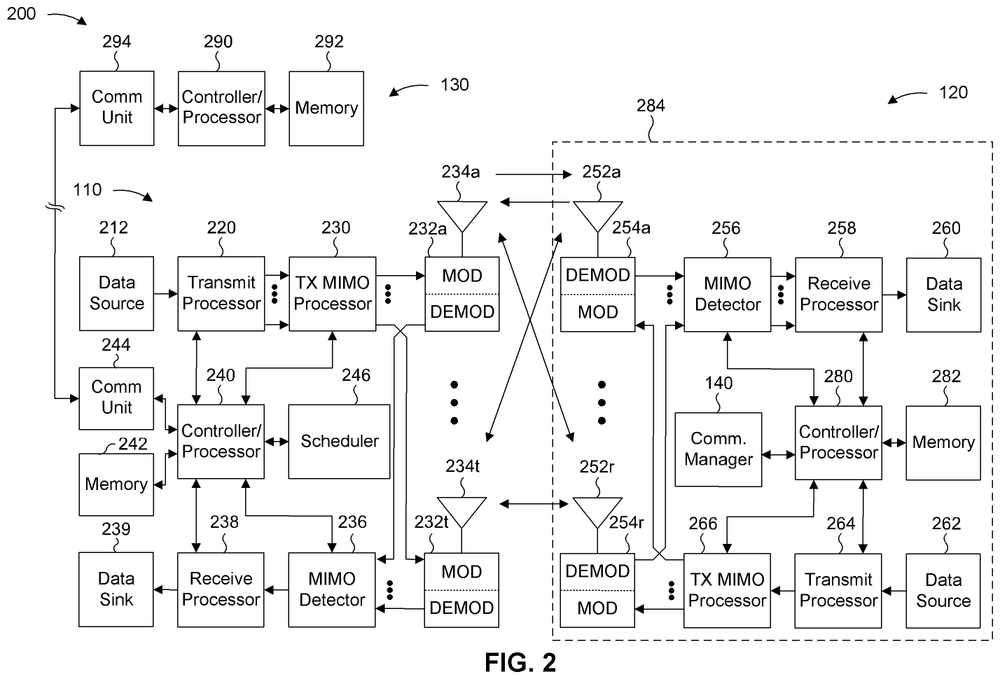

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

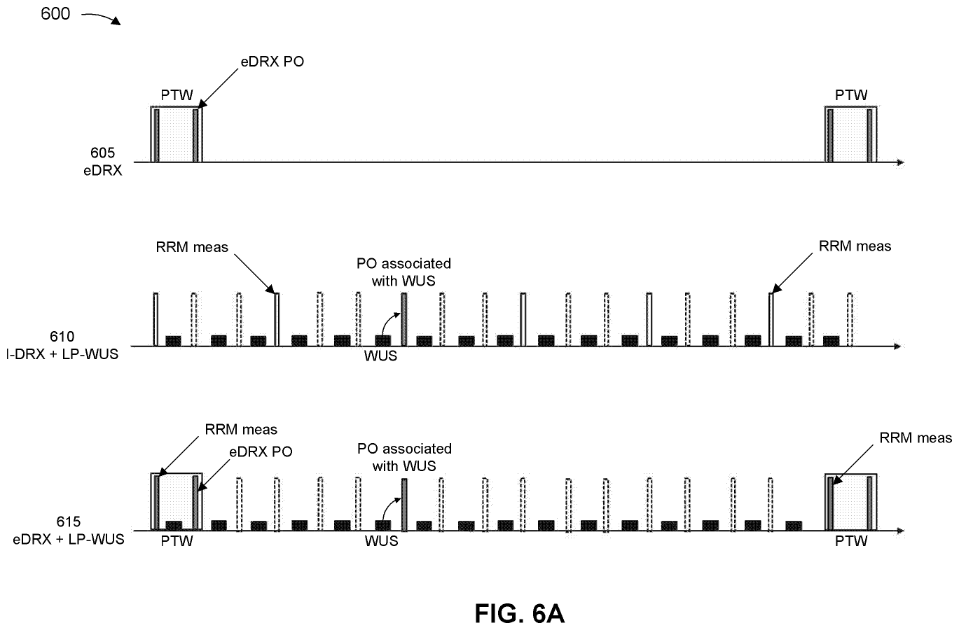

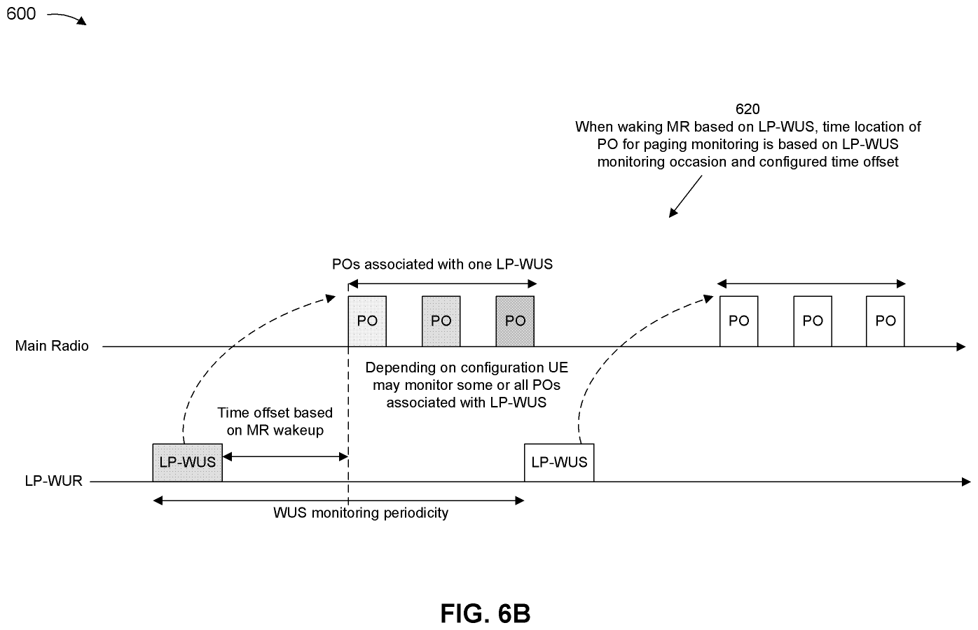

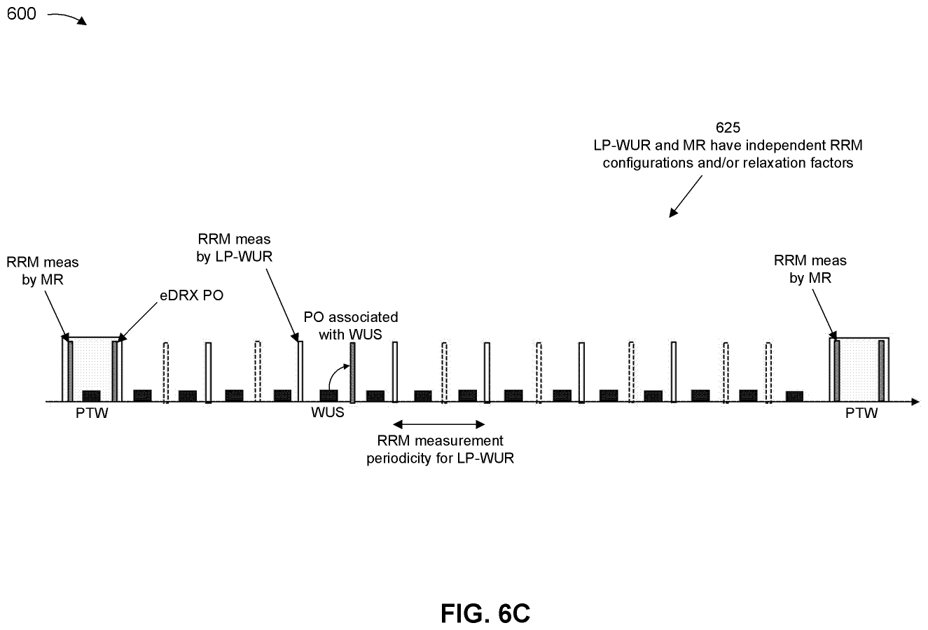

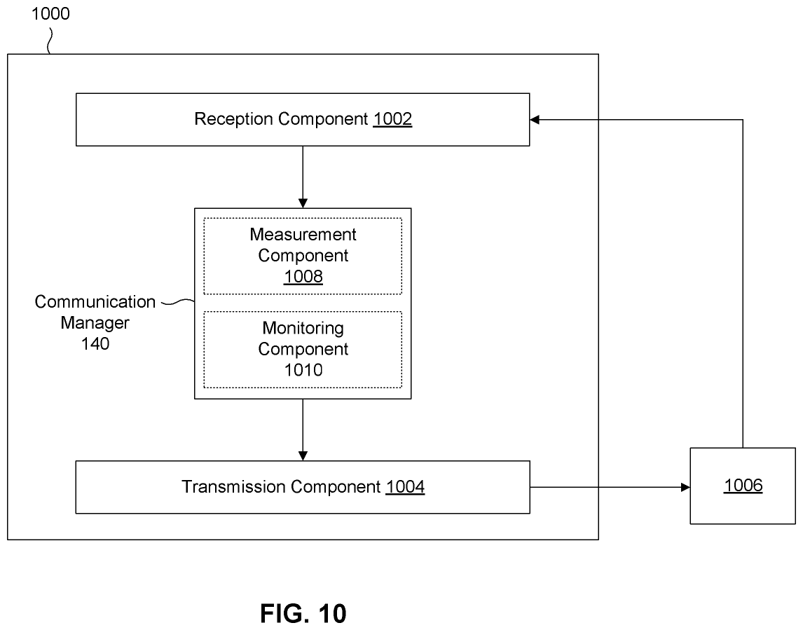

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-6C, FIG. 7, FIG. 8, FIG. 9, and/or FIG. 10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-6C, FIG. 7, FIG. 8, FIG. 9, and/or FIG. 10).

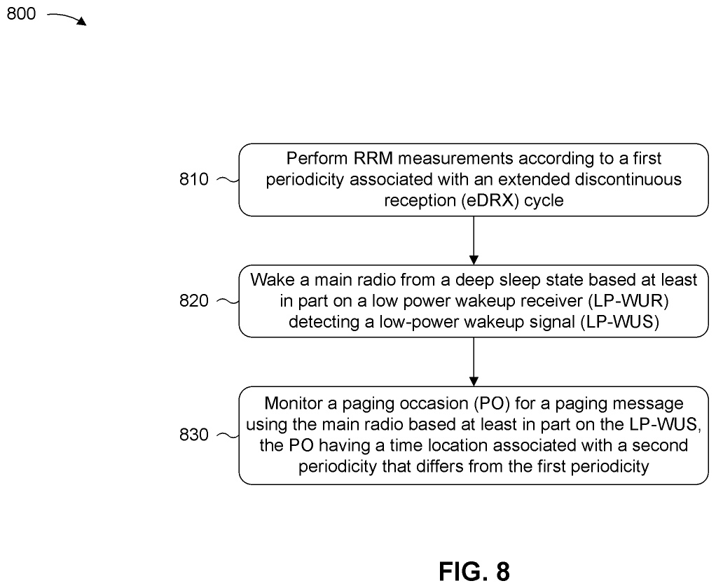

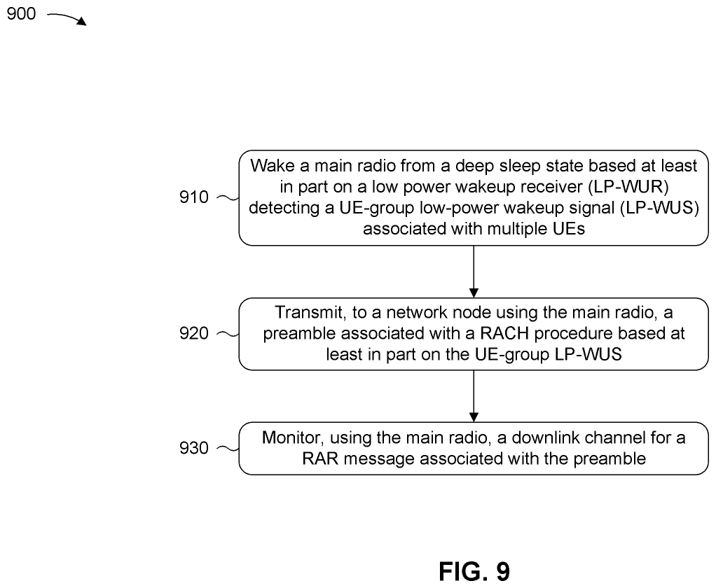

The controller/processor 240 of the network node 110, the controller/processor 280 of the UE 120, and/or any other component(s) of FIG. 2 may perform one or more techniques associated with combining LP-WUS and eDRX configurations, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for performing RRM measurements according to a first periodicity associated with an eDRX cycle; means for waking a main radio from a deep sleep state based at least in part on an LP-WUR detecting an LP-WUS; and/or means for monitoring a PO for a paging message using the main radio based at least in part on the LP-WUS, the PO having a time location associated with a second periodicity that differs from the first periodicity. Additionally, or alternatively, the UE 120 includes means for waking a main radio from a deep sleep state based at least in part on an LP-WUR detecting a UE-group LP-WUS associated with multiple UEs; means for transmitting, to a network node using the main radio, a preamble associated with a RACH procedure based at least in part on the UE-group LP-WUS; and/or means for monitoring, using the main radio, a downlink channel for a RAR message associated with the preamble. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

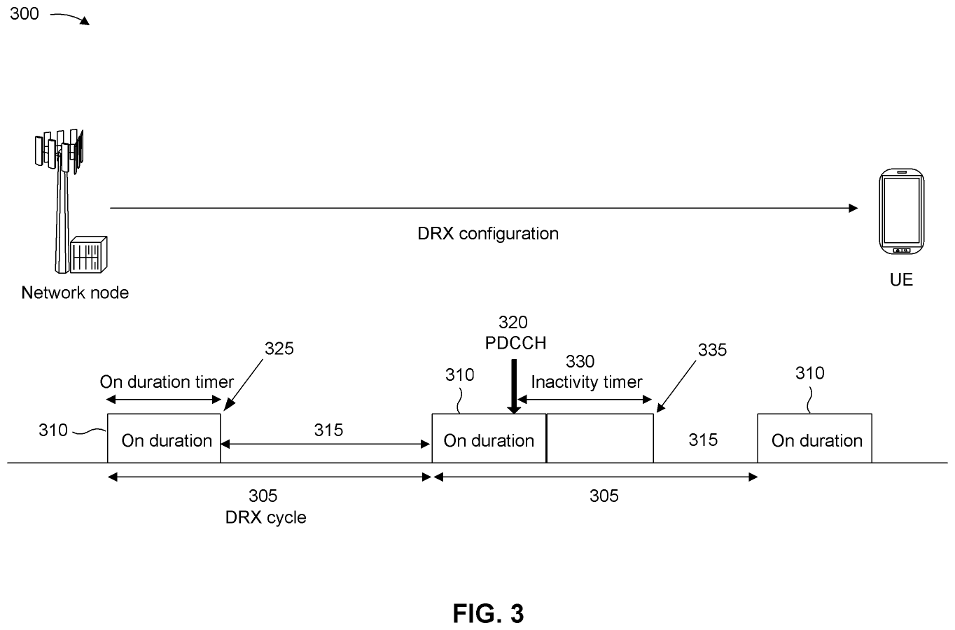

FIG. 3 is a diagram illustrating an example 300 of a discontinuous reception (DRX) configuration, in accordance with the present disclosure.

As shown in FIG. 3, a network node may transmit a DRX configuration to a UE to configure a DRX cycle 305 for the UE. The DRX cycle 305 may include a DRX on duration 310 (e.g., during which the UE is awake or in an active state) and an opportunity to enter a DRX sleep state 315. As used herein, the time during which the UE is configured to be in an active state during the DRX on duration 310 may be referred to as an active time, and the time during which the UE is configured to be in the DRX sleep state 315 may be referred to as an inactive time. As described below, the UE may monitor a physical downlink control channel (PDCCH) during the active time, and may refrain from monitoring the PDCCH during the inactive time.

During the DRX on duration 310 (e.g., the active time), the UE may monitor a downlink control channel (e.g., a PDCCH), as shown by reference number 320. For example, the UE may monitor the PDCCH for downlink control information (DCI) pertaining to the UE. If the UE does not detect and/or successfully decode any PDCCH communications intended for the UE during the DRX on duration 310, then the UE may enter the sleep state 315 (e.g., for the inactive time) at the end of the DRX on duration 310, as shown by reference number 325. In this way, the UE may conserve battery power and reduce power consumption. As shown, the DRX cycle 305 may repeat with a configured periodicity according to the DRX configuration.

If the UE detects and/or successfully decodes a PDCCH communication intended for the UE, then the UE may remain in an active state (e.g., awake) for the duration of a DRX inactivity timer 330 (e.g., which may extend the active time). The UE may start the DRX inactivity timer 330 at a time at which the PDCCH communication is received (e.g., in a transmission time interval (TTI) in which the PDCCH communication is received, such as a slot or a subframe). The UE may remain in the active state until the DRX inactivity timer 330 expires, at which time the UE may enter the sleep state 315 (e.g., for the inactive time), as shown by reference number 335. During the duration of the DRX inactivity timer 330, the UE may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE may restart the DRX inactivity timer 330 after each detection of a PDCCH communication for the UE for an initial transmission (e.g., but not for a retransmission). By operating in this manner, the UE may conserve battery power and reduce power consumption by entering the sleep state 315.

As indicated above, FIG. 3 is provided as an example. Other examples may differ from what is described with respect to FIG. 3.

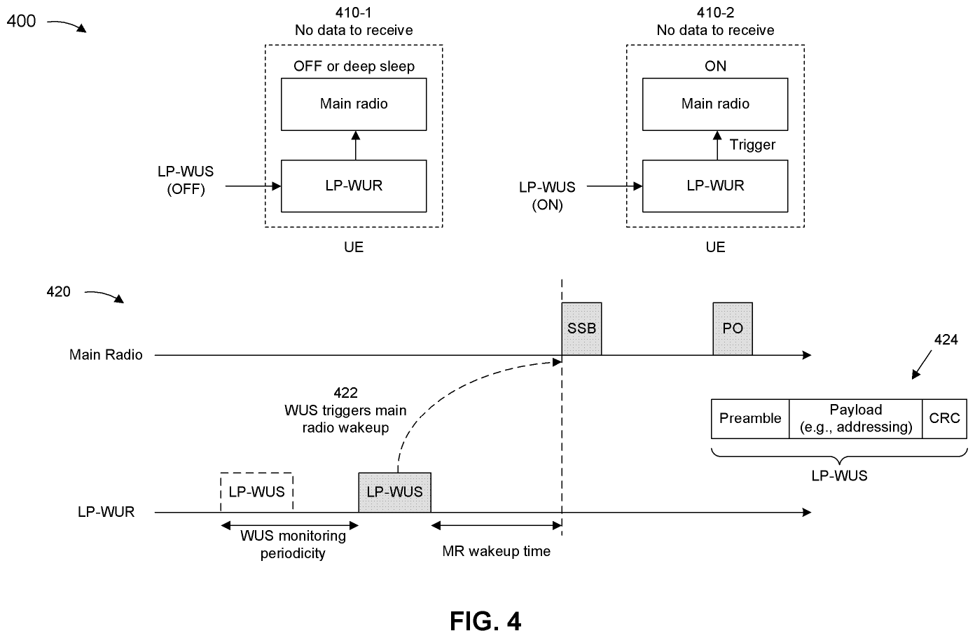

FIG. 4 is a diagram illustrating an example 400 of an LP-WUR and an LP-WUS, in accordance with the present disclosure. As shown in FIG. 4, a UE may be equipped with a communication system that includes a main radio (MR) and an LP-WUR to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 4, the UE may be equipped with the LP-WUR, which is a companion receiver that may be used with a main radio to reduce power consumption and latency.

For example, in some aspects, the UE may generally use the main radio to transmit and/or receive user data, and the main radio may be turned off or operated in a deep sleep state (e.g., a power state associated with one (1) relative power unit, as defined in TR 38.840) unless there is user data to transmit and/or receive. Furthermore, the LP-WUR may serve as a simple wakeup receiver for the main radio (e.g., the LP-WUR does not include a transmitter), and the LP-WUR may be active and monitoring for an LP-WUS while the main radio is off or in the deep sleep state. For example, reference number 410-1 depicts a first state associated with the main radio and the LP-WUR where there is no user data that the main radio needs to receive. In such cases, the main radio may be off or operated in the deep sleep state unless there is user data to transmit, and the LP-WUR may actively monitor for an LP-WUS (e.g., continuously or periodically in monitoring occasions that are separated in time). Furthermore, reference number 410-2 depicts a second state associated with the main radio and the LP-WUR where there is user data that the main radio needs to receive. In such cases, the LP-WUR may receive an LP-WUS (e.g., from a network node) and may provide a trigger to wake or otherwise activate the main radio based on detecting the LP-WUS. Accordingly, the main radio may then transmit and/or receive user data.

In general, the LP-WUR may consume very little power (e.g., a target power consumption less than 100 microwatts (μW) in the active state), which may be achieved using simple modulation schemes (e.g., on-off-keying (OOK)), a narrow bandwidth (e.g., less than 5 MHz), and/or other suitable techniques. In this way, the LP-WUR can be used to reduce the time that the main radio spends in an on state and/or may avoid unnecessarily waking the main radio from the off or deep sleep state when there is no user data to transmit or receive, which tends to be costly from a power consumption perspective. Furthermore, because the LP-WUR has a very low power consumption, the LP-WUR can be used to frequently or continuously perform LP-WUS monitoring, which may improve latency because the main radio can be woken up when there is user data that the main radio needs to receive (e.g., the LP-WUR does not suffer from the latency versus power efficiency tradeoff associated with duty cycling schemes, such as DRX). Furthermore, in addition to performing LP-WUS monitoring, which is mainly targeted at paging reception, the LP-WUR may monitor a low power reference signal (LP-RS) for time and frequency tracking and RRM measurement. In this way, by monitoring the LP-RS, serving cell and/or neighbor cell monitoring can be offloaded from the main radio to the LP-WUR to reduce how often the main radio is woken up, which can further reduce power consumption.

In some aspects, as shown by reference number 420, one application the LP-WUR is to monitor the LP-WUS for paging monitoring, which can be used to reduce unnecessary paging reception performed by the main radio. For example, as shown in FIG. 4, the LP-WUR may be configured to monitor for an LP-WUS (e.g., while the main radio is off or in a deep sleep state) according to a WUS monitoring periodicity (e.g., the LP-WUR may monitor for the LP-WUS in periodic LP-WUS monitoring occasions that are separated in time by the WUS monitoring periodicity). Alternatively, although not explicitly shown in FIG. 4, the LP-WUR may be configured to continuously monitor for the LP-WUS. In general, a network node may transmit an LP-WUS to a UE only in cases where there is a paging message that needs to be sent to the UE while the UE is in an idle or inactive state (e.g., a radio resource control (RRC) idle or RRC inactive state). In such cases, as shown by reference number 422, the LP-WUR may receive and detect the LP-WUS, which may trigger the LP-WUR to wake up the main radio. For example, as shown by reference number 424, the LP-WUS may be a message-based WUS, which may correspond to a packet that includes a preamble, a payload (e.g., a cell identifier or UE addressing for a paging early indication), and a cyclic redundancy code (CRC). Alternatively, in some aspects, the LP-WUS may be a sequence-based WUS, which may include a predefined set of sequences that depend on a cell identifier and/or an identifier associated with the UE. In either case, as shown, the main radio may wake up after a main radio wakeup time, and may then start to monitor one or more synchronization signal block (SSB) transmissions to obtain synchronization with the network node before monitoring and receiving the paging message in a subsequent PO. Otherwise, in cases where the LP-WUR does not detect the LP-WUS, the main radio may remain in the deep sleep state to save power.

As indicated above, FIG. 4 is provided as an example. Other examples may differ from what is described with regard to FIG. 4.

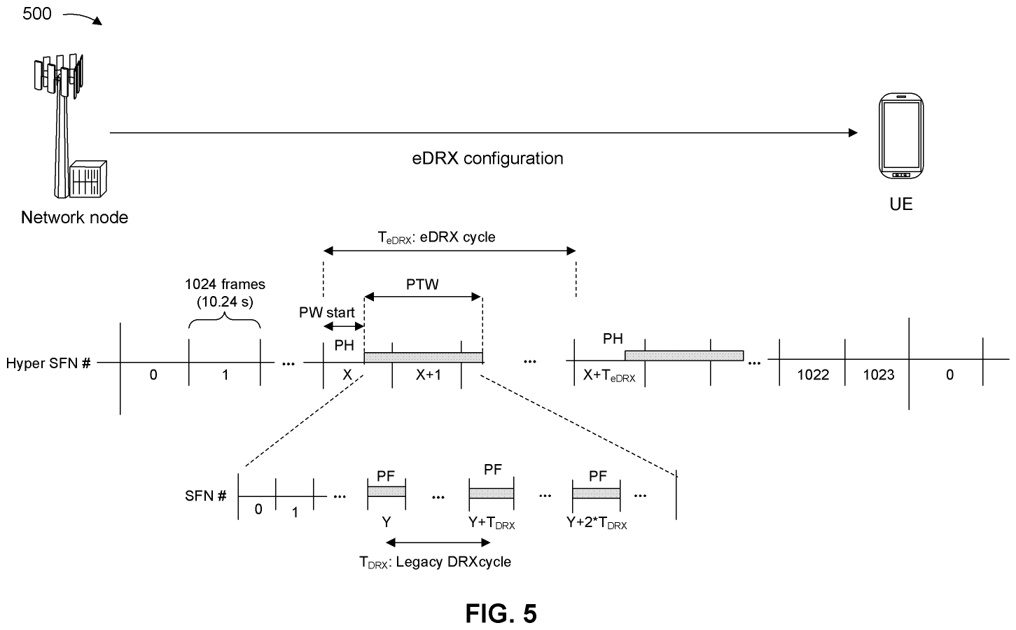

FIG. 5 is a diagram illustrating an example 500 of an extended DRX (eDRX) configuration, in accordance with the present disclosure.

As shown in FIG. 5, a network node may transmit an eDRX configuration to a UE to configure an eDRX cycle for the UE. For example, in some aspects, a core network may configure the eDRX cycle for the UE via non-access stratum (NAS) signaling, where the eDRX cycle may have a duration (shown as TeDRX) that can be significantly longer than a legacy DRX cycle (e.g., shown in FIG. 3) that is generally limited to at most 2.56 seconds (e.g., 256 frames that are one (1) millisecond each). On the other hand, an eDRX cycle configured for a UE in an RRC idle state may have a minimum duration of 2.56 seconds (e.g., corresponding to the maximum duration of a legacy DRX cycle) and a maximum duration of 10,485.76 seconds (e.g., up to 1024 hyperframes, each of which includes 1024 frames that are one (1) millisecond each).

In cases where the UE is configured with an eDRX cycle that is longer than 10.24 seconds (e.g., more than one (1) hyperframe), the UE may be configured with a paging time window (PTW) during which the UE follows legacy paging techniques based on the DRX cycle (e.g., the UE does not perform paging monitoring outside the PTW). For example, as shown, the PTW may include one or more subframes, a subset of which may be configured as a paging frame (PF) during which the UE performs paging monitoring. Furthermore, the UE may be configured to perform RRM measurements for a serving cell and one or more neighbor cells based on a DRX or eDRX cycle. For example, in some aspects, the RRM measurements may be performed every N DRX or eDRX cycles, where N has a value that depends on the duration of the DRX or eDRX cycles and no RRM measurements are performed outside the PTW for an eDRX cycle that exceeds 10.24 seconds.

As described herein, an eDRX cycle can potentially be very long (e.g., up to 10,485.76 seconds for a UE in an RRC idle state), which can enable significant power saving for delay-tolerant mobile terminated data (e.g., with a delay constraint of several minutes or more). However, the increased power savings may increase paging latency. Accordingly, in some cases, a UE equipped with an LP-WUR may use the LP-WUR to continuously monitor an LP-WUS or periodically monitor the LP-WUS with a very short duty cycle, which may significantly reduce the paging latency compared to eDRX. However, whether to enable an eDRX configuration or an LP-WUS configuration for a particular UE may depend on a use case associated with the UE. For example, for a UE associated with a mobility use case (e.g., an asset tracker or wearable device), frequent RRM measurements may be needed to support mobility. Accordingly, because an eDRX cycle is generally limited to performing RRM measurements within a PTW, an LP-WUS configuration for a UE associated with a mobility use case may be associated with an idle mode DRX (I-DRX) cycle (e.g., up to 2.56 seconds), and RRM measurements may be offloaded from a main radio to the LP-WUR to further improve power saving. However, in other use cases, such as a stationary UE (e.g., a wireless sensor or actuator in a fixed location), a combination of an LP-WUS configuration (e.g., up to 2.56 seconds) and an eDRX configuration (e.g., at least 2.56 seconds and up to tens of seconds or minutes) may work better to improve power savings because RRM measurements are naturally relaxed due to the UE having a fixed position, and the lengthy eDRX cycle may achieve significant power savings.

Accordingly, some aspects described herein relate to techniques to enable a combination of an LP-WUS configuration and an eDRX configuration. For example, some aspects described herein relate to techniques to assign, within an eDRX framework, a PO that a UE is to use for paging monitoring after the UE detects an LP-WUS via an LP-WUR. Otherwise, if a UE were to follow an eDRX cycle to determine the PO to use for paging monitoring, the low latency benefit offered by the LP-WUS configuration may not be achieved due to the lengthy eDRX cycle and the potentially large gap between the LP-WUS and the eDRX PO available for paging monitoring.

As indicated above, FIG. 5 is provided as an example. Other examples may differ from what is described with regard to FIG. 5.

FIGS. 6A-6C illustrating examples 600 associated with combining LP-WUS and eDRX configurations, in accordance with the present disclosure. As shown in FIGS. 6A-6C, examples 600 relate to RRM measurement and paging monitoring techniques that may be employed by a UE equipped with a main radio and an LP-WUR in cases the UE is configured with an eDRX configuration and LP-WUS configuration.

For example, in cases where the UE is configured with an eDRX configuration and an LP-WUS configuration, the UE may perform RRM measurements according to an RRM measurement periodicity associated with the eDRX cycle, and after detecting an LP-WUS the UE may monitor one or more POs for a paging message according to a paging monitoring periodicity that may have a different value than the RRM measurement periodicity. For example, in cases where the UE is configured to perform RRM measurements based on the eDRX cycle, the UE may wake the main radio and use the main radio perform the RRM measurements only during a PTW associated with the eDRX cycle (e.g., every N consecutive DRX cycles within a single PTW associated with an eDRX cycle, where the value of N is dependent on the eDRX periodicity). Furthermore, because the eDRX cycle can have a long duration, the paging monitoring periodicity may have a shorter duration than the RRM measurement periodicity (e.g., 1.28 or 2.56 seconds) in order to reduce paging latency when there is user data for the main radio to transmit or receive. For example, as described herein, the paging monitoring periodicity may generally refer to the periodicity associated with PO resources that the UE monitors for paging DCI using the main radio after the LP-WUR wakes the main radio based on detecting an LP-WUS while the main radio is off or in a deep sleep state. In some aspects, the periodicity associated with PO resources that are monitored for the paging DCI may be the same as or different from the periodicity used to monitor for the LP-WUS (e.g., in cases where the LP-WUR periodically monitors for the LP-WUS).

Accordingly, as described herein, a UE associated with LP-WUS and eDRX configurations may generally perform RRM measurements associated with the eDRX configuration during a PTW using a main radio according to an RRM measurement periodicity associated with the eDRX cycle, and may use the LP-WUR to monitor for an LP-WUS when the main radio is off or in a deep sleep state (e.g., outside the PTW). In some aspects, when the LP-WUR detects the LP-WUS, the LP-WUR may wake the main radio based on the LP-WUS, and the main radio may then monitor one or more POs for a paging message, where the one or more POs have corresponding time locations associated with the paging monitoring periodicity that may differ from the RRM measurement periodicity. For example, when the main radio is woken up based on the LP-WUR detecting the LP-WUS, the time location of the one or more POs that are monitored for the LP-WUS may be determined according to a periodicity value that corresponds to an LP-WUS monitoring periodicity (e.g., when the LP-WUS is monitored in periodic LP-WUS monitoring occasions), a wakeup time associated with the main radio, a default I-DRX paging cycle that may be broadcast in a system information block (SIB), and/or another suitable periodicity value that may be configured by higher layer (e.g., RRC) signaling.

In such cases, legacy equations for determining a paging frame and/or paging occasion may be used, except that a parameter T that represents a DRX cycle length in radio frames may be based on the periodicity value for the monitored POs rather than the DRX or eDRX cycle configured for the UE. For example, in some aspects, a PF may occur in a frame number that satisfies the following equation:

$$( SFN + {PF}_{offset} ) mod T = \frac{T}{N} \times ( {UE}_{ID} mod N )$$

where SFN is a frame number (e.g., a system frame number), PF_{offset} is a PF offset value, Tis the configured periodicity for the POs that are monitored by the main radio after being woken up based on an LP-WUS, Nis a minimum of T or a value nB broadcast in a SIB (e.g., with a value of 47, 2T, T, T/2, T/4, T/8, T/16, or T/32), and UE_{ID} is an identifier associated with the UE. Furthermore, an index is that indicates an index of the PO within the paging frame may be determined by the following equation:

$${i}_{s} = ⌊ \frac{{UE}_{ID}}{N} ⌋ mod {N}_{s}$$

where Nₛ is a maximum of one (1) or

$$\frac{n B}{T} .$$

Accordingly, when the LP-WUR detects an LP-WUS and wakes the main radio to monitor a PO for a paging message, the UE may use the equations provided above to determine the time location of the PO that is monitored for the paging message based on the configured periodicity value (e.g., the LP-WUS monitoring periodicity, a wakeup time associated with the main radio, default I-DRX paging cycle, and/or a higher layer configured periodicity value). Furthermore, the main radio may be associated with a wakeup time (e.g., a minimum amount of time that the main radio needs to transition from the off or deep sleep state to an active state in which PO monitoring can occur), whereby the PO that the UE monitors using the main radio may be an earliest PO that satisfies the main radio wakeup time after detection of the LP-WUS by the LP-WUR.

Accordingly, referring to FIG. 6A, reference numbers 605, 610, and 615 depict different examples of POs that a UE may monitor based on different power saving configurations. For example, reference number 605 depicts an example where the UE is configured with an eDRX cycle only without an LP-WUS, which may be suitable for a delay-tolerant stationary UE (e.g., a stationary UE without a low-latency requirement). For example, as shown by reference number 605, the UE may perform RRM measurements and PO monitoring only within a PTW, and the UE does not perform RRM measurements or PO monitoring outside the PTW. Accordingly, in this case, configuring the UE with an eDRX cycle only may increase power savings because there is no RRM measurement or PO monitoring activity outside the PTW, but this configuration can increase latency in cases where there is user data to be received by the UE (e.g., if user data arrives shortly after the PTW, the UE would not perform paging monitoring again until the next PTW, which can delay reception of the user data).

Accordingly, in another example, reference number 610 depicts a power saving configuration where the UE is configured with an I-DRX cycle and an LP-WUS configuration, which may be suitable for a non-stationary (e.g., mobile) UE that has a low latency requirement. For example, in a non-stationary use case, the UE may need to perform frequent RRM measurements for mobility, and the LP-WUS configuration may be used to reduce the latency associated with waking the main radio when there is user data to deliver to the UE. In this example, the I-DRX cycle may have a duration up to 2.56 seconds, and relatively frequent RRM measurements may be configured based on the I-DRX cycle (e.g., in FIG. 6A, RRM measurements are performed every fourth I-DRX cycle) to support mobility for the UE. Furthermore, as shown, the LP-WUR may wake the main radio when an LP-WUS is detected, and the main radio may monitor an I-DRX PO associated with the LP-WUS. However, as described herein, the RRM measurements are performed relatively frequently, which may increase power consumption relative to the eDRX configuration.

Accordingly, in another example, reference number 615 depicts a power saving configuration where the UE is configured with an eDRX cycle (e.g., at least 2.56 seconds and potentially much longer) and an LP-WUS configuration, which may be suitable for use cases where the UE is stationary and has a low-latency requirement. In this case, as shown, the UE may perform RRM measurements within a PTW associated with the eDRX cycle (e.g., every N consecutive DRX cycles within a single PTW associated with an eDRX cycle, where the value of Nis dependent on the eDRX periodicity) and the UE does not perform RRM measurements outside the PTW. Furthermore, in some aspects, the UE may also be configured to monitor one or more POs that occur within the PTW. In addition, the main radio may be turned off or operated in a deep sleep state outside the PTW, during which time the LP-WUR may monitor for an LP-WUS. In this case, as shown, the LP-WUR may wake the main radio to monitor a PO for a paging message intended for the UE based on the LP-WUR detecting an LP-WUS. Furthermore, when an LP-WUS is detected, the PO that is monitored for the paging message may be determined using the techniques described in further detail above.

As shown in FIG. 6B, and by reference number 620, the time location of the PO that the main radio uses for paging monitoring (e.g., after being woken up by the LP-WUR based on detection of an LP-WUS) may be based on an LP-WUS monitoring occasion in which the LP-WUS was detected and a configured time offset. For example, referring to FIG. 6B, reference number 620 depicts an example where the LP-WUR periodically monitors for the LP-WUS in LP-WUS monitoring occasions that are separated in time by a WUS monitoring periodicity. Accordingly, when the LP-WUR detects an LP-WUS in an LP-WUS monitoring occasion, the LP-WUR may wake the main radio, and a PO that the main radio monitors for a paging message may be based on the LP-WUS monitoring occasion and the time offset that is based on the wakeup time for the main radio. For example, in some aspects, a one-to-one association may be configured between an LP-WUS monitoring occasion and a corresponding PO with a time offset that is based on the main radio wakeup time, which the UE may report to a network node. In such cases, when the LP-WUR detects an LP-WUS in an LP-WUS monitoring occasion, the LP-WUR may wake the main radio, which may monitor the corresponding PO that has a one-to-one associated with the LP-WUS monitoring occasion in which the LP-WUS was detected. Alternatively, as shown in FIG. 6B, one L-WUS monitoring occasion may be associated with multiple POs (e.g., when there are multiple UEs that need to be woken up by the same LP-WUS or an exact wakeup time for the main radio is unknown due to a dependence on a receive signal-to-noise ratio (SNR)). In such cases, the UE may use the main radio to monitor one or more (e.g., all) of the multiple POs that are associated with the LP-WUS monitoring occasion in which the LP-WUS was detected. Alternatively, in cases where the LP-WUR is configured to continuously monitor for the LP-WUS when the main radio is off or in the deep sleep state, a set of POs with a periodicity equal to the main radio wakeup time may be defined, and the main radio may be configured to monitor an earliest PO in the set of POs that satisfies the main radio wakeup time when the LP-WUS is detected. Furthermore, in cases where the LP-WUS is transmitted with multiple repetitions, a timing reference for the LP-WUS monitoring occasion may be defined as a first symbol or a last symbol of the LP-WUS monitoring occasion (rather than a first symbol or a last symbol of the LP-WUS that is detected in the LP-WUS monitoring occasion, because the number of repetitions of the LP-WUS may be unknown to the UE).

As shown in FIG. 6C, and by reference number 625, the LP-WUR and the main radio may have independent RRM configurations and/or RRM measurement relaxation factors. For example, as described herein, RRM measurements may be performed by the main radio (e.g., every N consecutive DRX cycles within a single PTW associated with an eDRX cycle, where the value of N is dependent on the eDRX periodicity) and/or by the LP-WUR (e.g., outside the PTW based on an RRM measurement periodicity for the LP-WUR). In some aspects, in cases where the LP-WUR is configured to perform RRM measurements outside the PTW, the RRM measurement periodicity for the LP-WUR can be independent from the periodicity for the RRM measurements that are performed by the main radio within the PTW. For example, in some aspects, the RRM measurement periodicity for the LP-WUR may be based on a multiple of an LP-WUS monitoring periodicity.

However, in cases where RRM measurements for the LP-WUR are also configured (e.g., in addition to paging monitoring), RRM measurements performed by the main radio can be further relaxed (e.g., the main radio can perform RRM measurements less frequently within a single PTW associated with an eDRX cycle, or the RRM measurements may be relaxed for multiple PTWs instead of individually relaxed for each PTW). In general, the relaxation factor applied to the RRM measurements performed by the main radio may be based on one or more conditions, such as the LP-WUR having a capability to reliably detect the LP-WUS, where the relaxation factor may be applied to the RRM measurements performed by the main radio if the one or more conditions are satisfied or not applied. Additionally, or alternatively, one or more conditions may be defined to force the main radio to perform RRM measurements. For example, when RRM measurements are configured for the LP-WUR, the main radio may be configured to also perform RRM measurements in cases where a hypothetical block error rate (BLER) and/or misdetection rate for the LP-WUS satisfies (e.g., exceeds) a radio link failure (RLF) threshold. Furthermore, as described herein, the eDRX cycle can be used as a fallback mechanism for paging monitoring. For example, in some aspects, the UE may be configured to wake the main radio in each eDRX period or multiple eDRX periods regardless of whether an LP-WUS is detected, and may be configured to monitor an eDRX PO for a paging message in the PTW associated with each eDRX period or multiple eDRX periods. In such cases, if the UE were to detect a paging message from the network node in an eDRX PO but no paging message is detected via an LP-WUS, the UE may take action based on potential reliability problems with the LP-WUS (e.g., signaling a failure to detect an LP-WUS from the network node) and/or deactivate the LP-WUR for paging monitoring and/or RRM measurements. As another example, the RRM measurements performed by the main radio within the PTW can be used for determining whether to deactivate the LP-WUR for paging monitoring and/or RRM measurement.

As indicated above, FIGS. 6A-6C are provided as an example. Other examples may differ from what is described with regard to FIGS. 6A-6C.

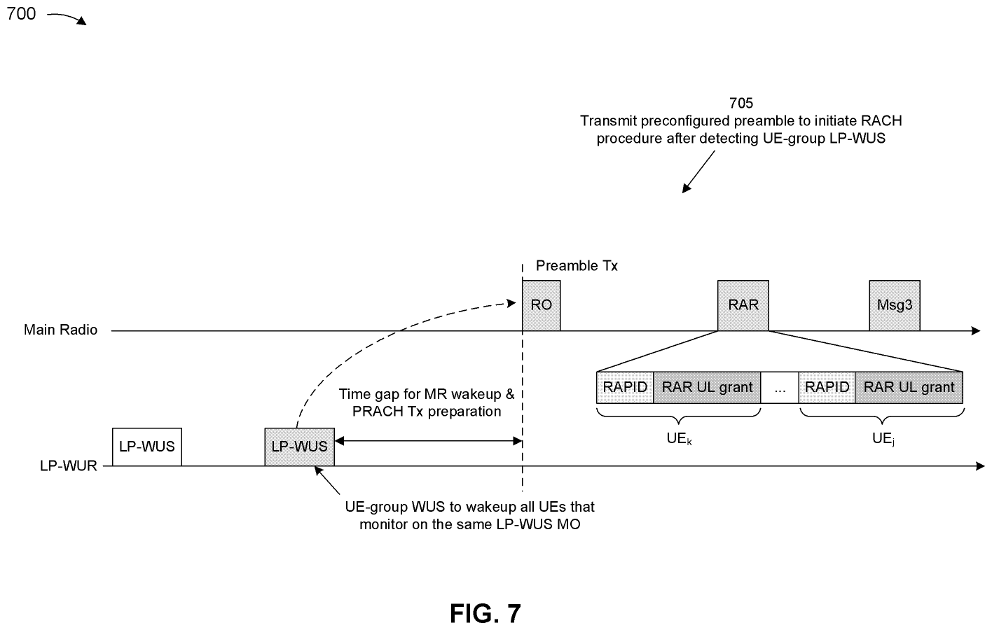

FIG. 7 is a diagram illustrating an example 700 associated with UE behavior after detecting a UE-group LP-WUS, in accordance with the present disclosure. As shown in FIG. 7, example 700 relates to behavior of a UE equipped with a main radio and an LP-WUR that may monitor for an LP-WUS while the main radio is off or in a deep sleep state. In particular, example 700 relates to a RACH procedure that the UE may initiate when a UE-group LP-WUS is detected. More particularly, as described herein, the RACH procedure that the UE initiates when a UE-group LP-WUS is detected may be based on a four-step RACH procedure.

For example, in a typical four-step RACH procedure, the UE may transmit a random access message (RAM), which may include a preamble (sometimes referred to as a random access preamble, a physical RACH (PRACH) preamble, or a RAM preamble) to a network node. The message that includes the preamble may be referred to as a message 1, msg1, MSG1, a first message, or an initial message in a four-step RACH procedure. The random access message may include a random access preamble identifier. The network node may then transmit an RAR message to the UE as a reply to the preamble. The RAR message may be referred to as message 2, msg2, MSG2, or a second message in a four-step RACH procedure. In some aspects, the RAR message may indicate the detected random access preamble identifier (e.g., received from the UE in msg1). Additionally, or alternatively, the RAR message may indicate a resource allocation to be used by the UE to transmit message 3 (msg3). Furthermore, as part of the second step of the four-step RACH procedure, the network node may transmit a PDCCH communication for the RAR message. The PDCCH communication may schedule a PDSCH communication that includes the RAR message. For example, the PDCCH communication may indicate a resource allocation for the PDSCH communication. Also as part of the second step of the four-step RACH procedure, the network node may transmit the PDSCH communication for the RAR message, as scheduled by the PDCCH communication. The UE may then transmit an RRC connection request message, which may be referred to as message 3, msg3, MSG3, or a third message of a four-step RACH procedure. In some aspects, the RRC connection request may include a UE identifier, uplink control information (UCI), and/or a PUSCH communication (e.g., an RRC connection request). The network node may then transmit an RRC connection setup message, which may be referred to as message 4, msg4, MSG4, or a fourth message of a four-step RACH procedure. In some aspects, the RRC connection setup message may include the detected UE identifier, a timing advance value, and/or contention resolution information. If the UE successfully receives the RRC connection setup message, the UE may transmit an acknowledgement to the network node, and may then enter an RRC connected state.

Accordingly, in cases where the LP-WUS that the UE detects via the LP-WUR is a UE-group LP-WUS used to wake up multiple UEs that monitor the LP-WUS monitoring occasion in which the UE-group LP-WUS is transmitted, FIG. 7 illustrates UE behavior that may occur based on detection of the UE-group LP-WUS, which may be different from UE behavior that occurs when a UE-dedicated LP-WUS is detected. For example, as shown by reference number 705, the UE transmit a preamble to initiate a RACH procedure based on detecting a UE-group LP-WUS used to wake up all UEs that monitor the same LP-WUS monitoring occasion. For example, in some aspects, the preamble may be a preconfigured UE-dedicated preamble that a network node provides to the UE (e.g., in an RRC release message) when the UE is transitioned to an RRC inactive or RRC idle state. Alternatively, in some aspects, the preconfigured preamble may not be preconfigured and/or may not be dedicated to the UE. For example, the UE may randomly select the preamble that is transmitted when the UE-group LP-WUS is detected from a set of PRACH preambles. In this example, the UE may use a two-step RACH procedure to respond to the reception of the UE-group LP-WUS by transmitting a PRACH preamble followed by a msgA PUSCH in which an identifier of the UE is included. Based on the UE identifier included in the msgA PUSCH, the network node may determine whether the UE has a paging message and may transmit a msgB communication to the UE if there is a paging message to be transmitted to the UE. Furthermore, as shown, the UE may transmit the preamble in a RACH occasion after detection of the UE-group LP-WUS, where the RACH occasion used to transmit the preamble is defined with respect to an associated LP-WUS monitoring occasion in which the UE-group LP-WUS was detected and a configured time gap that is based on a wakeup time for the main radio and a PRACH preparation time. Accordingly, after the UE transmits the preamble, the UE may wait for a RAR message from the network node.

For example, in cases where the network node receives the preamble from the UE and determines that there is a paging message to be transmitted to the UE, the RAR message that the network node transmits to the UE may include an index associated with the preamble transmitted by the UE in addition to an acknowledgement of a paging message for the UE or a PO configuration for paging monitoring. Alternatively, in cases where the network node receives the preamble from the UE and determines that there is no paging message to be transmitted to the UE, the network node does not include the index associated with the preamble transmitted by the UE in the RAR message transmitted to the UE. In such cases, when the UE receives the RAR message that does not include the index associated with the preamble transmitted by the UE, the UE may determine that the main radio was falsely woken up by the UE-group LP-WUS, and the UE may transition the main radio back to the off or deep sleep state and continue to monitor for the LP-WUS using the LP-WUR. In the former case, where there is a paging message to be transmitted to the UE, the RAR message used for acknowledging a paging message to the UE can have the same format as used in legacy techniques (e.g., may include an uplink grant for msg3, a timing advance command, and a temporary cell radio network temporary identity (TC-RNTI)). Alternatively, the RAR message may be reformatted by replacing the uplink grant for msg3 with a dedicated PO configuration for paging reception, in which case the UE may continue to monitor for the paging message in the configured PO rather than transmitting msg3. Accordingly, when the RAR message includes the index associated with the preamble transmitted by the UE, the UE may monitor a PDCCH candidate in a search space set using the main radio, where the search space set may be based at least in part on a paging message acknowledgement or a search space set configuration indicated in the RAR message.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with combining LP-WUS and eDRX configurations.

As shown in FIG. 8, in some aspects, process 800 may include performing RRM measurements according to a first periodicity associated with an eDRX cycle (block 810). For example, the UE (e.g., using communication manager 140 and/or measurement component 1008, depicted in FIG. 10) may perform RRM measurements according to a first periodicity associated with an eDRX cycle, as described above.

As further shown in FIG. 8, in some aspects, process 800 may include waking a main radio from a deep sleep state based at least in part on an LP-WUR detecting an LP-WUS (block 820). For example, the UE (e.g., using communication manager 140 and/or monitoring component 1010, depicted in FIG. 10) may wake a main radio from a deep sleep state based at least in part on an LP-WUR detecting an LP-WUS, as described above.

As further shown in FIG. 8, in some aspects, process 800 may include monitoring a PO for a paging message using the main radio based at least in part on the LP-WUS, the PO having a time location associated with a second periodicity that differs from the first periodicity (block 830). For example, the UE (e.g., using communication manager 140 and/or monitoring component 1010, depicted in FIG. 10) may monitor a PO for a paging message using the main radio based at least in part on the LP-WUS, the PO having a time location associated with a second periodicity that differs from the first periodicity, as described above.

Process 800 may include additional aspects, such as any single aspect or any combination of aspects described below and/or in connection with one or more other processes described elsewhere herein.

In a first aspect, the RRM measurements are performed using the main radio within a PTW associated with the eDRX cycle.

In a second aspect, alone or in combination with the first aspect, the second periodicity is based at least in part on one or more of a monitoring periodicity associated with the LP-WUS, a wakeup time associated with the main radio, an I-DRX paging cycle, or a periodicity value indicated in one or more signaling messages.

In a third aspect, alone or in combination with one or more of the first and second aspects, the time location associated with the PO is based at least in part on a periodic LP-WUS monitoring occasion in which the LP-WUS is detected and a configured time offset.

In a fourth aspect, alone or in combination with one or more of the first through third aspects, the time location associated with the PO is based at least in part on a one-to-one association between the periodic LP-WUS monitoring occasion and the monitored PO.

In a fifth aspect, alone or in combination with one or more of the first through fourth aspects, the monitored PO is included in a group of multiple POs that are associated with the periodic LP-WUS monitoring occasion.

In a sixth aspect, alone or in combination with one or more of the first through fifth aspects, a timing reference for the periodic LP-WUS monitoring occasion is a first symbol or a last symbol within the periodic LP-WUS monitoring occasion.

In a seventh aspect, alone or in combination with one or more of the first through sixth aspects, the PO that is monitored for the paging message is an earliest PO that satisfies a wakeup time associated with the main radio based at least in part on the LP-WUR continuously monitoring for the LP-WUS while the main radio is in the deep sleep state.

In an eighth aspect, alone or in combination with one or more of the first through seventh aspects, process 800 includes receiving a configuration for performing RRM measurements using the LP-WUR at a third periodicity that is independent from the first periodicity associated with the eDRX cycle.

In a ninth aspect, alone or in combination with one or more of the first through eighth aspects, the RRM measurements are performed using the main radio with a relaxation factor applied to the first periodicity based at least in part on the LP-WUR being configured to perform the RRM measurements.

In a tenth aspect, alone or in combination with one or more of the first through ninth aspects, the RRM measurements are performed using the main radio based at least in part on one or more conditions being satisfied.

In an eleventh aspect, alone or in combination with one or more of the first through tenth aspects, process 800 includes monitoring, using the main radio, an eDRX PO associated with the eDRX cycle for a paging message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with UE behavior after detecting a UE-group LP-WUS.

As shown in FIG. 9, in some aspects, process 900 may include waking a main radio from a deep sleep state based at least in part on an LP-WUR detecting a UE-group LP-WUS associated with multiple UEs (block 910). For example, the UE (e.g., using communication manager 140 and/or monitoring component 1010, depicted in FIG. 10) may wake a main radio from a deep sleep state based at least in part on an LP-WUR detecting a UE-group LP-WUS associated with multiple UEs, as described above.

As further shown in FIG. 9, in some aspects, process 900 may include transmitting, to a network node using the main radio, a preamble associated with a RACH procedure based at least in part on the UE-group LP-WUS (block 920). For example, the UE (e.g., using communication manager 140 and/or transmission component 1004, depicted in FIG. 10) may transmit, to a network node using the main radio, a preamble associated with a RACH procedure based at least in part on the UE-group LP-WUS, as described above.

As further shown in FIG. 9, in some aspects, process 900 may include monitoring, using the main radio, a downlink channel for a RAR message associated with the preamble (block 930). For example, the UE (e.g., using communication manager 140 and/or monitoring component 1010, depicted in FIG. 10) may monitor, using the main radio, a downlink channel for a RAR message associated with the preamble, as described above.

Process 900 may include additional aspects, such as any single aspect or any combination of aspects described below and/or in connection with one or more other processes described elsewhere herein.

In a first aspect, process 900 includes receiving the RAR message from the network node, and transitioning the main radio to the deep sleep state based at least in part on the received RAR message not including an index associated with the transmitted preamble.

In a second aspect, alone or in combination with the first aspect, process 900 includes receiving the RAR message from the network node, and monitoring a PDCCH candidate in a search space set using the main radio based at least in part on the received RAR message including an index associated with the transmitted preamble, wherein the search space set is based at least in part on a paging message acknowledgement or a search space set configuration indicated by the RAR message.

In a third aspect, alone or in combination with one or more of the first and second aspects, a RACH occasion in which the preamble is transmitted is based at least in part on an LP-WUS monitoring occasion in which the LP-WUS is detected and a configured gap associated with waking the main radio and preparing the main radio to transmit the preamble.

In a fourth aspect, alone or in combination with one or more of the first through third aspects, the preamble is dedicated to the UE and indicated in an RRC message releasing the UE to an inactive state.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a measurement component 1008 or a monitoring component 1010, among other examples.

In some aspects, the apparatus 1000 may be configured to perform one or more operations described herein in connection with FIGS. 6A-6C and/or FIG. 7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable (e.g., directly, indirectly, after pre-processing, or without pre-processing) by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The measurement component 1008 may perform RRM measurements according to a first periodicity associated with an eDRX cycle. The monitoring component 1010 may wake a main radio from a deep sleep state based at least in part on an LP-WUR detecting an LP-WUS. The monitoring component 1010 may monitor a PO for a paging message using the main radio based at least in part on the LP-WUS, the PO having a time location associated with a second periodicity that differs from the first periodicity.

The monitoring component 1010 may wake a main radio from a deep sleep state based at least in part on an LP-WUR detecting a UE-group LP-WUS associated with multiple UEs. The transmission component 1004 may transmit, to a network node using the main radio, a preamble associated with a RACH procedure based at least in part on the UE-group LP-WUS. The monitoring component 1010 may monitor, using the main radio, a downlink channel for a RAR message associated with the preamble.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: performing RRM measurements according to a first periodicity associated with an eDRX cycle; waking a main radio from a deep sleep state based at least in part on an LP-WUR detecting an LP-WUS; and monitoring a PO for a paging message using the main radio based at least in part on the LP-WUS, the PO having a time location associated with a second periodicity that differs from the first periodicity.

Aspect 2: The method of Aspect 1, wherein the RRM measurements are performed using the main radio within a PTW associated with the eDRX cycle.

Aspect 3: The method of any of Aspects 1-2, wherein the second periodicity is based at least in part on one or more of a monitoring periodicity associated with the LP-WUS, a wakeup time associated with the main radio, an I-DRX paging cycle, or a periodicity value indicated in one or more signaling messages.

Aspect 4: The method of any of Aspects 1-3, wherein the time location associated with the PO is based at least in part on a periodic LP-WUS monitoring occasion in which the LP-WUS is detected and a configured time offset.

Aspect 5: The method of Aspect 4, wherein the time location associated with the PO is based at least in part on a one-to-one association between the periodic LP-WUS monitoring occasion and the monitored PO.

Aspect 6: The method of any of Aspects 4-5, wherein the monitored PO is included in a group of multiple POs that are associated with the periodic LP-WUS monitoring occasion.

Aspect 7: The method of any of Aspects 4-6, wherein a timing reference for the periodic LP-WUS monitoring occasion is a first symbol or a last symbol within the periodic LP-WUS monitoring occasion.

Aspect 8: The method of any of Aspects 1-7, wherein the PO that is monitored for the paging message is an earliest PO that satisfies a wakeup time associated with the main radio based at least in part on the LP-WUR continuously monitoring for the LP-WUS while the main radio is in the deep sleep state.

Aspect 9: The method of any of Aspects 1-8, further comprising: receiving a configuration for performing RRM measurements using the LP-WUR at a third periodicity that is independent from the first periodicity associated with the eDRX cycle.

Aspect 10: The method of Aspect 9, wherein the RRM measurements are performed using the main radio with a relaxation factor applied to the first periodicity based at least in part on the LP-WUR being configured to perform the RRM measurements.

Aspect 11: The method of Aspect 10, wherein the RRM measurements are performed using the main radio based at least in part on one or more conditions being satisfied.

Aspect 12: The method of any of Aspects 9-11, further comprising: monitoring, using the main radio, an eDRX PO associated with the eDRX cycle for a paging message.

Aspect 13: A method of wireless communication performed by a UE, comprising: waking a main radio from a deep sleep state based at least in part on an LP-WUR detecting a UE-group LP-WUS associated with multiple UEs; transmitting, to a network node using the main radio, a preamble associated with a RACH procedure based at least in part on the UE-group LP-WUS; and monitoring, using the main radio, a downlink channel for a RAR message associated with the preamble.

Aspect 14: The method of Aspect 13, further comprising: receiving the RAR message from the network node; and transitioning the main radio to the deep sleep state based at least in part on the received RAR message not including an index associated with the transmitted preamble.

Aspect 15: The method of any of Aspects 13-14, further comprising: receiving the RAR message from the network node; and monitoring a PDCCH candidate in a search space set using the main radio based at least in part on the received RAR message including an index associated with the transmitted preamble, wherein the search space set is based at least in part on a paging message acknowledgement or a search space set configuration indicated by the RAR message.

Aspect 16: The method of any of Aspects 13-15, wherein a RACH occasion in which the preamble is transmitted is based at least in part on an LP-WUS monitoring occasion in which the LP-WUS is detected and a configured gap associated with waking the main radio and preparing the main radio to transmit the preamble.

Aspect 17: The method of any of Aspects 13-16, wherein the preamble is dedicated to the UE and indicated in an RRC message releasing the UE to an inactive state.

Aspect 18: An apparatus for wireless communication at a device, comprising a processor; memory coupled with the processor; and instructions stored in the memory and executable by the processor to cause the apparatus to perform the method of one or more of Aspects 1-17.

Aspect 19: A device for wireless communication, comprising a memory and one or more processors coupled to the memory, the one or more processors configured to perform the method of one or more of Aspects 1-17.

Aspect 20: An apparatus for wireless communication, comprising at least one means for performing the method of one or more of Aspects 1-17.

Aspect 21: A non-transitory computer-readable medium storing code for wireless communication, the code comprising instructions executable by a processor to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
performing radio resource management (RRM) measurements according to a first periodicity associated with an extended discontinuous reception (eDRX) cycle;
waking a main radio from a deep sleep state based at least in part on a low power wakeup receiver (LP-WUR) detecting a low-power wakeup signal (LP-WUS); and
monitoring a paging occasion (PO) for a paging message using the main radio based at least in part on the LP-WUS, the PO having a time location associated with a second periodicity that differs from the first periodicity.

2. The method of claim 1, wherein the RRM measurements are performed using the main radio within a paging time window associated with the eDRX cycle.

3. The method of claim 1, wherein the second periodicity is based at least in part on one or more of a monitoring periodicity associated with the LP-WUS, a wakeup time associated with the main radio, an idle mode discontinuous reception (I-DRX) paging cycle, or a periodicity value indicated in one or more signaling messages.

4. The method of claim 1, wherein the time location associated with the PO is based at least in part on a periodic LP-WUS monitoring occasion in which the LP-WUS is detected and a configured time offset.

5. The method of claim 4, wherein the time location associated with the PO is based at least in part on a one-to-one association between the periodic LP-WUS monitoring occasion and the monitored PO.

6. The method of claim 4, wherein the monitored PO is included in a group of multiple POs that are associated with the periodic LP-WUS monitoring occasion.

7. The method of claim 4, wherein a timing reference for the periodic LP-WUS monitoring occasion is a first symbol or a last symbol within the periodic LP-WUS monitoring occasion.

8. The method of claim 1, wherein the PO that is monitored for the paging message is an earliest PO that satisfies a wakeup time associated with the main radio based at least in part on the LP-WUR continuously monitoring for the LP-WUS while the main radio is in the deep sleep state.

9. The method of claim 1, further comprising:
receiving a configuration for performing RRM measurements using the LP-WUR at a third periodicity that is independent from the first periodicity associated with the eDRX cycle.

10. The method of claim 9, wherein the RRM measurements are performed using the main radio with a relaxation factor applied to the first periodicity based at least in part on the LP-WUR being configured to perform the RRM measurements.

11. The method of claim 10, wherein the RRM measurements are performed using the main radio based at least in part on one or more conditions being satisfied.

12. The method of claim 9, further comprising:
monitoring, using the main radio, an eDRX PO associated with the eDRX cycle for a paging message.

13. A method of wireless communication performed by a user equipment (UE), comprising:
waking a main radio from a deep sleep state based at least in part on a low power wakeup receiver (LP-WUR) detecting a UE-group low-power wakeup signal (LP-WUS) associated with multiple UEs;
transmitting, to a network node using the main radio, a preamble associated with a random access channel (RACH) procedure based at least in part on the UE-group LP-WUS; and
monitoring, using the main radio, a downlink channel for a random access response (RAR) message associated with the preamble.

14. The method of claim 13, further comprising:
receiving the RAR message from the network node; and
transitioning the main radio to the deep sleep state based at least in part on the received RAR message not including an index associated with the transmitted preamble.

15. The method of claim 13, further comprising:
receiving the RAR message from the network node; and
monitoring a physical downlink control channel (PDCCH) candidate in a search space set using the main radio based at least in part on the received RAR message including an index associated with the transmitted preamble, wherein the search space set is based at least in part on a paging message acknowledgement or a search space set configuration indicated by the RAR message.

16. The method of claim 13, wherein a RACH occasion in which the preamble is transmitted is based at least in part on an LP-WUS monitoring occasion in which the LP-WUS is detected and a configured gap associated with waking the main radio and preparing the main radio to transmit the preamble.

17. The method of claim 13, wherein the preamble is dedicated to the UE and indicated in a radio resource control message releasing the UE to an inactive state.

18. A user equipment (UE) for wireless communication, comprising:
memory; and
one or more processors coupled to the memory, the memory storing instructions executable by the one or more processors to cause the UE to:
perform radio resource management (RRM) measurements according to a first periodicity associated with an extended discontinuous reception (eDRX) cycle;
wake a main radio from a deep sleep state based at least in part on a low power wakeup receiver (LP-WUR) detecting a low-power wakeup signal (LP-WUS); and
monitor a paging occasion (PO) for a paging message using the main radio based at least in part on the LP-WUS, the PO having a time location associated with a second periodicity that differs from the first periodicity.

19. The UE of claim 18, wherein the RRM measurements are performed using the main radio within a paging time window associated with the eDRX cycle.

20. The UE of claim 18, wherein the second periodicity is based at least in part on one or more of a monitoring periodicity associated with the LP-WUS, a wakeup time associated with the main radio, an idle mode discontinuous reception (I-DRX) paging cycle, or a periodicity value indicated in one or more signaling messages.

21-30. (canceled)
